(19) United States
(12) Patent Application Publication
(10) Pub. No.: US 2008/0044708 A1
(43) Pub. Date: Feb. 21, 2008

(54) HYDROCARBON-BASED POLYMER FOR USE OF A FUEL CELL

(75) Inventors: Takeo Yamaguchi, Bunkyo-ku (JP); Jimmy Lawrence, Bunkyo-ku (JP); Koichi Yamashita, Bunkyo-ku (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: THE UNIVERSITY OF TOKYO, Tokyo (JP)

(21) Appl. No.: 11/562,232

(22) Filed: Nov. 21, 2006

Related U.S. Application Data
(60) Provisional application No. 60/739,534, filed on Nov. 25, 2005.

(51) Int. Cl. H01M 8/10; C08G 75/00

(52) U.S. Cl. 429/33; 436/6; 528/391

(57) ABSTRACT

The present invention provides a hydrocarbon-based polymer for use in an electrolyte membrane of a fuel cell having high durability, an electrolyte membrane of a fuel cell using the polymer, a fuel cell using the electrolyte membrane. The present invention provides a hydrocarbon-based polymer comprising a repeating unit, wherein a value of an HOMO (Highest Occupied Molecular Orbital), obtained according to a quantum chemical calculation, of a calculated oligomer having four successive units, each of which is the repeating unit, is lower than a control HOMO value, obtained according to the quantum chemical calculation, of a control oligomer having four successive repeating units, each of which is represented by the formula (I):

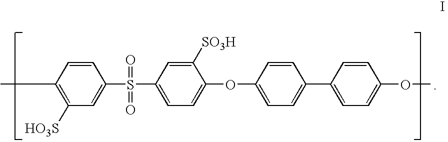

### BACKGROUND OF THE INVENTION

1. Field of the Invention

The present invention relates to a hydrocarbon-based polymer having high durability, and particularly to a highly durable hydrocarbon polymer applied for various uses in materials for fuel cells such as electrolyte membranes of fuel cells. The present invention, also, relates to a method for selecting the polymer.

2. Related Art

With the concern for fossil fuel depletion or the environment in mind, fuel cells such as a solid polymer electrolyte fuel cell (PEFC) having advantages such as a high energy conversion efficiency and low discharge amounts of NOx and SOx are expected as a new energy source.

PEFC is composed of an electrode and an electrolyte membrane. The electrolyte membrane is considered as an element that defines the durability of the PEFC (see, Non-Patent Document 1 or 2). Fluorine-containing polymers such as Nafion® have generally been used as an electrolyte membrane of the PEFC; however, the durability thereof becomes an issue when they are used at high temperatures of about 70 to 120° C.

Accordingly, these days, alternative polymers to the Nafion®, such as sulfonated aromatic hydrocarbon-based polymers having low cost and high heat resistance, are variously studied (see Non-Patent Document 1).

Non-Patent Document 1: Bae, et al. Solid State Ionics, 2002, 147, 1-2.

Non-Patent Document 2: T. N. Buchi, et al., Electrochim. Acta, 1995, 40.

Non-Patent Document 3: Hickner, M. A., et al., Chem. Revs. 2004, 104, 4587-4611.

### SUMMARY OF THE INVENTION

It is known, however, that the sulfonated aromatic hydrocarbon-based polymers are weak against the attack by hydrogen peroxide or OH radicals derived therefrom, which are considered as causes for deteriorating electrolyte membranes.

An object of the present invention is to provide a hydrocarbon-based polymer having high durability, particularly hydrocarbon-based polymer used for materials for fuel cells, especially used as fuel cell electrolytes; and a material for a fuel cell, an electrolyte membrane of a fuel cell and/or a fuel cell, which use the polymer.

In order to attain the object, the present inventors have earnestly studied, and, as a result, have found the following.

They found that the deterioration of various sulfonated aromatic hydrocarbon-based polymers is caused by the decomposition of the polymers. Further, they considered that the decomposition of the polymers is caused by OH radicals generated from hydrogen peroxide.

Typically, oxygen reacts with a proton or electron to produce water at a cathode. However, if oxygen reacts with two electrons during the reaction or when it permeates to an anode, hydrogen peroxide is generated. The hydrogen peroxide may decompose at a high temperature under an acidic condition to produce OH radicals, and the OH radicals may decompose and deteriorate the polymer. Thus, the present inventors have found that a polymer having resistance to the attack by OH radicals is a hydrocarbon polymer for an electrolyte membrane of a fuel cell having high durability. The present inventors have accomplished the following inventions based on the finding.

<1> A hydrocarbon-based polymer comprising a repeating unit, wherein a value of an HOMO (Highest Occupied Molecular Orbital), obtained according to a quantum chemical calculation, of a calculated oligomer having four successive units, each of which is the repeating unit, is lower than a control HOMO value, obtained according to the quantum chemical calculation, of a control oligomer having four successive repeating units, each of which is represented by the formula (I):

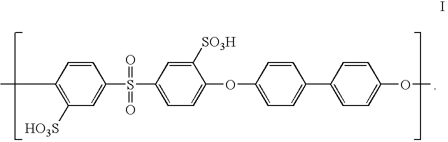

<2> In the above item <1>, a position of the HOMO, obtained according to the quantum chemical calculation, of the calculated oligomer may not be in a central portion of a main chain of the calculated oligomer. In particular, the position of the HOMO may not be located in either of a second repeating unit or a third repeating unit in the calculated oligomer.

<3> In the above item <1> or <2>, an absolute value of the HOMO value, obtained according to the quantum chemical calculation, of the calculated oligomer may be 1.1 times or more, more preferably 1.15 times or more, most preferably 1.2 times or more larger than an absolute value of the control HOMO value.

<4> In any one of the above items <1> to <3>, an LUMO (Lowest Unoccupied Molecular Orbital), obtained according to the quantum chemical calculation, of the calculated oligomer may not be localized in the calculated oligomer. The LUMO may be uniformly dispersed in the calculated oligomer. Further, the position of the LUMO may not be the same as the position of the HOMO. Furthermore, even if the LUMO is localized in the calculated oligomer, the position of the LUMO may be in either of a first repeating unit or a forth repeating unit in the calculated oligomer.

<5> In any one of the above items <1> to <4>, the calculated oligomer may exclude an oligomer in which the LUMO, obtained according to the quantum chemical calculation, is located in either of a second repeating unit or a third repeating unit in the calculated oligomer.

<6> In anyone of the above items <1> to <5>, the polymer may have a terminal group which makes the absolute value of the HOMO larger.

<7> In any one of the above items <1> to <6>, the polymer may have proton conductivity.

<8> In any one of the above items <I> to <7>, the polymer may be used for a material for use in a fuel cell.

<9> In any one of the above items <1> to <8>, the polymer may be used for an electrolyte membrane of a fuel cell.

<10> A polymer comprising a repeating unit represented by the formula (II) wherein each of A and B may independently represent 0 to 4 substituents:

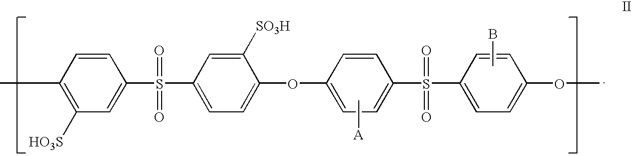

<11> In the above item <10>, the polymer may be used for a material for use in a fuel cell.

<12> In the above item <10> or <11>, the polymer may be used for an electrolyte membrane of a fuel cell.

<13> A hydrocarbon-based polymer comprising a repeating unit represented by the formula (III) (in which X represents a bivalent group including a single bond. For example, X may include, but are not limited to, a single bond, S, O, SO₂, CO, a bivalent group having 1 to 12 carbon atoms (for example, —(CH₂)ₙ— or —(CF₂)ₘ— where in n and m each independently represents an integer of to 12. Furthermore, H or F may be substituted with various substituents in —(CH₂)— or —(CF₂)ₘ—.). Each of A′ and B′ independently represents to 4 substituents), wherein a value of an HOMO (Highest Occupied Molecular Orbital), obtained according to a quantum chemical calculation, of a calculated oligomer having four successive repeating units, each of which is the repeating unit represented by the formula (III), is lower than a control HOMO value, obtained according to the quantum chemical calculation, of a control oligomer having four successive repeating units, each of which is represented by the formula (I):

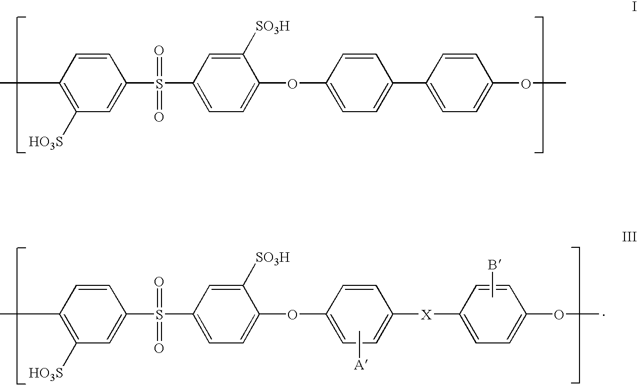

<14> In the above item <13>, a position of the HOMO, obtained according to the quantum chemical calculation, of the calculated oligomer may not be in a central portion of a main chain of the calculated oligomer. In particular, the position of the HOMO may not be located in either of a second repeating unit or a third repeating unit in the calculated oligomer.

<15> In the above item <13> or <14>, an absolute value of the HOMO value, obtained according to the quantum chemical calculation, of the calculated oligomer may be 1.1 times or more, more preferably 1.15 times or more, most preferably 1.2 times or more larger than an absolute value of the control HOMO value.

<16> In any one of the above items <13> to <15>, the quantum chemical calculation may be semiempirical quantum calculation, PM5, and the HOMO value may be −1.5 eV, more preferably −2.5 eV, most preferably −3 eV lower than the control HOMO value.

<17> In any one of the above items <13> to <16>, an LUMO (Lowest Unoccupied Molecular Orbital), obtained according to the quantum chemical calculation, of the calculated oligomer may not be localized in the calculated oligomer. The LUMO may be uniformly dispersed in the calculated oligomer. Further, the position of the LUMO may not be the same as the position of the HOMO. Furthermore, even if the LUMO is localized in the calculated oligomer, the position of the LUMO may be in either of a first repeating unit or a forth repeating unit in the calculated oligomer.

<18> In any one of the above items <13> to <17>, the calculated oligomer may exclude an oligomer in which the LUMO, obtained according to the quantum chemical calculation, is located in either of a second repeating unit or a third repeating unit in the calculated oligomer.

<19> In any one of the above items <13> to <18>, the polymer may have a terminal group which makes the absolute value of the HOMO value larger.

<20> In any one of the above items <13> to <19>, the polymer may have proton conductivity.

<21> In any one of the above items <13> to <20>, the polymer may be used for a material for use in a fuel cell.

<22> In any one of the above items <13> to <21>, the polymer may be used for an electrolyte membrane of a fuel cell.

<23> A material for use in a fuel cell comprising the polymer defined in any one of the above items <1> to <22>.

<24> An electrolyte membrane used for a fuel cell comprising the polymer defined in any one of the above items <1> to <22>.

<25> A fuel cell comprising the polymer defined in any one of the above items <1> to <22>.

<26> A method for selecting a highly durable polymer comprising the steps of:

calculating a calculated value of an HOMO (Highest Occupied Molecular Orbital) of a calculated oligomer having four successive repeating units, each of which is a repeating unit of the polymer of interest, according to an quantum chemical calculation;

calculating a control HOMO value of a control oligomer having four successive repeating units, each of which is represented by the formula (I), according to the quantum chemical calculation; and

comparing the calculated HOMO value with the control HOMO value, and selecting the polymer of interest, which comprises the repeating unit, as a highly durable polymer, if the calculated HOMO value is lower than the control HOMO value.

<27> In the above item <26>, if a position of the HOMO, obtained according to the quantum chemical calculation, of the calculated oligomer is not in a central portion of a main chain of the calculated oligomer, the polymer may be selected as a highly durable polymer. In particular, the polymer may be selected as a highly durable polymer, in which the position of the HOMO may not be located in either of a second repeating unit or a third repeating unit in the calculated oligomer.

<28> In the above item <26> or <27>, an absolute value of the HOMO value, obtained according to the quantum chemical calculation, of the calculated oligomer may be 1.1 times or more, more preferably 1.15 times or more, most preferably 1.2 times or more larger than an absolute value of the control HOMO value.

<29> In any one of the above items <26> to <28>, the method may further comprise the step of:

selecting the polymer comprising the repeating units as a highly durable polymer, if an LUMO (Lowest Unoccupied Molecular Orbital), obtained according to the quantum chemical calculation, of the calculated oligomer is not localized in the calculated oligomer. The LUMO may be uniformly dispersed in the calculated oligomer, and therefore the polymer comprising such repeating unit has high durablity. Further, the position of the LUMO may not be the same as the position of the HOMO, and therefore the polymer comprising such repeating unit has high durablity. Furthermore, even if the LUMO is localized in the calculated oligomer, the position of the LUMO may be in either of a first repeating unit or a forth repeating unit in the calculated oligomer, and therefore the polymer comprising such repeating unit may have high durablity.

<30> In any one of the above items <26> to <29>, the method may further comprise the step of:

excluding the polymer comprising the repeating unit, if the LUMO, obtained according to the quantum chemical calculation, of the calculated oligomer is located in a second repeating unit or third repeating unit of the calculated oligomer.

<31> In any one of the above items <26> to <30>, a polymer having a terminal group which makes the absolute value of the HOMO of the calculated oligomer larger may be selected as a highly durable polymer.

<32> A method for selecting a polymer having a durability to OH radical comprising the steps of:

preparing a 0.15 wt % aqueous solution comprising a homopolymer consisting of repeating units having an ion exchange group;

adding 1.5 wt % hydrogen peroxide to the aqueous solution and allowing the mixture to stand at 60° C.;

sampling a small amount from the mixture one hour after the mixture is started to allow to stand at 60° C. (0 hour) and adding isopropanol to the sample to stop the reaction thus obtaining a reaction product; and

measuring a molecular weight of the resulting reaction product,

wherein when a value obtained by normalizing the molecular weight of the reaction product with the molecular weight of the homopolymer ((Molecular weight of the reaction product)/(Molecular weight of a homopolymer)*100) is 50 or more, preferably 60 or more, more preferably 80 or more, most preferably or more, the polymer comprising the repeating unit is judged as a polymer having durability to OH radical.

<33> In the above item <32>, the method may further comprise a step of measuring a content of remaining ion exchange groups of the resulting reaction product,

wherein when the content of the remaining ion exchange groups is 50% or more, preferably 70% or more, more preferably 80% or more, most preferably 99% or more, the polymer comprising the repeating unit may be judged as a polymer having durability to OH radical.

<34> The polymer comprising the repeating units of the above item <32> or <33> may have the feature(s) defined in any one of the above items <26> to <31>.

### BRIEF DESCRIPTION OF DRAWINGS

FIG. 1 is a graph showing comparison of the state of the polymer SPES-a before each test (spectrum shown as “initial”) the IR spectrum (shown as “OH-test”) after the accelerated resistance test (OH radical test), and the IR spectrum (shown as “Heat test”) after the heat resistance test.

FIG. 2 is a graph showing results of IPC measurements.

FIG. 3 is a graph showing results of GPC.

FIG. 4 is a graph showing a decomposition pattern of the polymers SPES-a (FIG. 4(a)), SPES-b (FIG. 4(b)), and SPES-c (FIG. 4(c)).

FIG. 5 is a graph showing a polydispersity (Mw/Mn) obtained from the samples in the accelerated resistance test.

FIG. 6 is a graph showing calculation results in two decomposition mechanisms.

FIG. 7 is a graph showing that a decomposition pattern of the polymer SPES-c can be reproduced by an extended model.

FIG. 8 is a graph showing calculation results of the stabilization energy when OH radicals approach to the polymer, obtained using the semi-empirical quantum calculation.

FIG. 9 is a graph showing resistance indexes, wherein the horizontal axis shows HOMO calculation values, and the vertical axis shows percentages of the molecular weight after 30 minutes from decomposition.

### DETAILED DESCRIPTION OF THE INVENTION

Hereinafter, the present invention will be described in detail.

The present invention relates to a hydrocarbon-based polymer having high durability, in particular a hydrocarbon-based polymer which is used as a material for a fuel cell, especially as an electrolyte of a fuel cell.

The term “hydrocarbon-based polymer” as used herein means a polymer excluding a halogenated polymer comprising a main chain consisting of carbon atom and halogen atoms, such as Nafion®. In particular, in the present invention, the “hydrocarbon-based polymer” may be an aromatic hydrocarbon-based polymer containing a benzene ring(s) in a repeating unit.

The polymer according to the present invention may have proton conductivity. The proton conductivity may be S/cm or higher, preferably 0.01 S/cm or higher, at a temperature of −50° C. to 200° C. and under a circumstance at any moisture vapor pressure.

The polymer according to the present invention is characterized by comprising a repeating unit (hereinafter the certain repeating unit is referred to as repeating unit “A”, for an explanation), and characterized in that a calculated value of an HOMO, obtained according to a quantum chemical calculation of a calculated oligomer having four successive repeating units “A” (AAAA) is lower than a control HOMO value of a control oligomer having four successive repeating units (BBBB) represented by the formula (I) (hereinafter the repeating unit represented by the formula (I) is referred to as repeating unit “B”, for an explanation). In the present application, the calculated “oligomer” and the control “oligomer” which “have four successive repeating units” are used in view of a calculation time according to a quantum chemical calculation, and the like, but “oligomers” having “more than four” successive repeating units may be used with technological advances in performance of computers for calculation. In this case, the numbers of repeating units in the calculated oligomer and the control oligomer may be the same with each other.

Polymers according to the present invention will be described in more detail.

In the present invention, the “calculated oligomer” is an oligomer “AAAA,” which consists of four successive repeating units “A”, and it is only used for a calculation according to a quantum chemical calculation. That is, the “calculated oligomer” refers to an oligomer consisting of four successive repeating units, each of which is the repeating unit of the polymer of interest, and which is only used for obtaining a calculation result according to a quantum chemical calculation. For the “calculated oligomer,” an HOMO is calculated according to a certain quantum chemical calculation. When the calculated HOMO value is lower than a control HOMO value, obtained according to the same quantum chemical calculation, of a control oligomer (BBBB), the polymer comprising a repeating unit “A” provides high durability.

Preferably, an absolute value of the calculated HOMO value of the “calculated oligomer” may be 1.1 times or more, preferably 1.15 times or more, more preferably 1.2 times or more, larger than an absolute value of the control HOMO value. The HOMO value is generally a “negative” value. Thus, when the absolute values are compared and the value is 1.1 times or more, preferably 1.15 times or more, more preferably 1.2 times or more, the polymer comprising such repeating unit (s) can provide resistance to OH radicals, and high durability.

In the calculation of control HOMO values, a control oligomer has —OH group (which is not —O—OH group but —O—H group) at the right terminal group and the —H at the left terminal group in the formula (I).

The control oligomer (BBBB) consisting of the repeating units “B,” as shown in Examples mentioned below, shows a certain resistance to OH radicals. Thus, a polymer having higher resistance to OH radicals than the certain resistance to OH radicals (having a lower HOMO value) shows high durability.

The polymer comprising repeating unit (s) “AA” may include homopolymer consisting of the repeating units “A”, and copolymers comprising the repeating unit (s) “A” and repeating units other than the repeating unit A. The copolymer may include various copolymers such as a block copolymer, an alternative copolymer, a graft copolymer, and a random copolymer.

Most preferably, the polymer according to the present invention may be a polymer wherein both HOMO and LUMO are not localized. The HOMO may not be located in a central portion of a main chain, in particular is not located in either of a second repeating unit or a third repeating unit in the calculated oligomer. In addition, an LUMO may not be localized in a main chain, in particular may not be located in a central portion of the main chain. In other words, the LUMO may be uniformly dispersed.

If the HOMO is located in the central portion of the main chain, the located position of the HOMO is attacked by OH radicals. The attack cuts off or breaks down a polymer from the central portion of the main chain, which cause a tendency that such a polymer does not have resistance to OH radicals, namely durability. The position of the LUMO may not be the same as that of the HOMO.

When the LUMO is not localized in a main chain, particularly is not located in a central portion of the main chain, the polymer shows resistance, namely high durability, to other radicals such as COO radicals, which are derived from OH radicals. Also, in the polymer according to the present invention, the LUMO may be located in either of a first repeating unit and/or a fourth repeating unit of the calculated oligomer. In other words, as to the polymer according to the present invention, the LUMO may not be located in either of a second repeating unit or a third repeating unit of the calculated oligomer. If the LUMO is located in either of a second repeating unit or a third repeating unit, or if the LUMO is in or around the central part of the polymer, other radicals derived from OH radicals, which are generated during a reaction process upon using a fuel cell, highly possibly attack the second repeating unit or the third repeating unit (the central portion of the polymer or around it). The polymer which is attacked by the other radicals derived from OH radicals is, accordingly, cut or broken at the central portion thereof, and thus such a polymer tends to have lower durability. Furthermore, if the LUMO is located in either of a first repeating unit or a fourth repeating unit of the calculated oligomer localize, namely the LUMO is located in the polymer ends or their vicinities, particularly in either of the first repeating units from its ends, the other radicals derived from OH radicals attack the polymer end or its vicinity. Although the polymer attacked is cut or broken at the polymer end, the durability tends to decrease less compared with a case in which the central portion is attacked.

Furthermore, since ends, namely terminal groups, of the polymer have a tendency that it is hard to be attacked by OH radicals or the other radicals derived from OH radicals to cut or break, such a polymer can have durability. Thus, polymers may have terminal groups which make the absolute value of the HOMO value larger.

Various methods such as various semiempirical quantum calculations and various ab initio methods may be used as the quantum chemical calculation. In any case, a “calculated oligomer” and a “control oligomer,” to be calculated, must be measured according to the same method.

In addition, the present invention provides a polymer comprising repeating units represented by the formula II wherein each of A and B independently represents 0 to 4 substituents, in particular a polymer which is used as a material for a fuel cell, especially as an electrolyte of a fuel cell.

The polymer comprising a repeating unit represented by the formula (II) has proton conductivity, and a feature that an HOMO value, obtained according to a quantum chemical calculation, of the calculated oligomer is lower than a control HOMO value. Also, the polymer comprising a repeating unit represented by the formula (II) has an LUMO located in a first repeating unit and/or a fourth repeating unit of the calculated oligomer, or does not have an LUMO located in a second repeating unit or a third repeating unit.

In the formula (II), A represents 0 to 4 substituents, and B. Examples of the substituents may include, but are not particularly limited to, —CH₃ and the like.

In addition, the present invention provides a hydrocarbon-based polymer comprising a repeating unit represented by the formula (III) wherein a value of an HOMO (Highest Occupied Molecular Orbital), obtained according to a quantum chemical calculation, of a calculated oligomer having four successive repeating units, each of which is the repeating unit represented by the formula (III), is lower than a control HOMO value, obtained according to the quantum chemical calculation, of a control oligomer having four successive repeating units, each of which is represented by the formula (I).

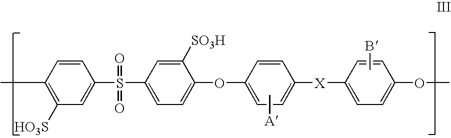

In the formula (III), X represents a bivalent group. Examples of X may include, but are not limited to, a single bond, a bivalent binding group having 1 to 12 carbon atoms such as —(CH₂)ₙ— or —(CF₂)ₘ— wherein each of n and m independently represents an integer of 1 to 12, and H or F in the —(CH₂)ₙ— or —(CF₂)ₘ— may be substituted with various substituents. Each of A′ and B′ independently represents 0 to 4 substituents. Examples of the group A′ and B′ may include, but are not limited to, —CH₃ group and the like.

The polymers may be used for materials for fuel cells. In particular, the polymers may be used for electrolyte membranes of a fuel cell. The electrolyte membranes of a fuel cell may consist of the polymer alone, or may comprise the polymer.

The present invention also provides a fuel cell comprising the polymer.

The present invention provides a method for selecting the polymer, namely the highly durable polymer.

The method of the present invention comprises the steps of:

calculating a calculated value of an HOMO (Highest Occupied Molecular Orbital) of a calculated oligomer having four successive repeating units, each of which the polymer comprises, according to an quantum chemical calculation;

calculating a control HOMO value of a control oligomer having four repeating units, each of which is represented by the formula (I), according to the quantum chemical calculation; and

comparing the calculated HOMO value with the control HOMO value, and selecting the polymer comprising the repeating unit as a highly durable polymer if the calculated HOMO value is lower than the control HOMO value.

In the method of the present invention, an absolute value of the HOMO value, obtained according to the quantum chemical calculation, of the calculated oligomer may be 1.1 times or more, preferably 1.15 times or more, more preferably 1.2 times or more larger than an absolute value of the control HOMO value.

In addition, the method may further comprise a first selection investigation step in which when an LUMO (Lowest Unoccupied Molecular Orbital), obtained according to a quantum chemical calculation, of the calculated oligomer is located in a first repeating unit and/or a fourth repeating unit of the calculated oligomer, the polymer comprising the repeating unit is selected as a highly durable polymer.

Further, the method may further comprise a second selection investigation step in which when an LUMO, obtained according to a quantum chemical calculation, of the calculated oligomer is located in either of a second repeating unit or a third repeating unit in the calculated oligomer, the polymer comprising the repeating unit is excluded from a highly durable polymer.

Also, a polymer having a terminal group which makes the absolute value of the HOMO value of the calculated oligomer larger is selected as a highly durable polymer.

The quantum chemical calculation used for determining HOMO values or LUMO values in the present invention will be described.

The quantum chemical calculation can be performed using any commercially available computer software. When the calculation is performed, a calculated oligomer (or control oligomer) is optimized according to a molecular dynamics calculation, MM, and then an HOMO value or a LUMO position of the oligomer is calculated using an AMl method, a PM3 method or a PM5 method. In addition, the positions of the HOMO and the LUMO are found by calculating their electorn densities.

Further, accessibility of OH radicals to the calculated oligomer (or the control oligomer), and a reaction route of OH radicals to the calculated oligomer (or control oligomer) can be calculated.

The accessibility of OH radicals to the calculated oligomer (or control oligomer), can be performed, for example, as follows:

First, the structures of the calculated oligomer and OH radical are optimized separately according to a molecular dynamics calculation, an MM method followed by a PM3 method. Next, a position of each atom in an adduct which adds parallel to the calculated oligomer (or control oligomer) is optimized at a distance of 2 angstrom from an atom which attacks OH radical. The calculated value of the energy, obtained in the optimization calculation, is compared with a calculated result obtained for a different atom. Briefly speaking, according to the calculation, the stability can be studied when OH radical is in a specific distance from the polymer. It is meant that the lower the energy is, the more likely the OH radical approaches the atom.

A reaction route of OH radical-calculated oligomer (control oligomer) is calculated, for instance, as follows:

First, the structures of the calculated oligomer and OH radical are optimized separately according to a molecular dynamics calculation, an MM method followed by a PM3 method. Next, while OH radical is brought close to the calculated oligomer from an initial condition in a 0.1 angstrom step, the structure is optimized to give a plot of an energy change (up to 1 angstrom) at a distance of 2 angstrom from an atom which attacks OH radical. Similarly, the calculation in case where OH radical is distanced away from the calculated oligomer (up to 3 angstrom) is performed, and a structure of a transition state, having the highest energy value, is sought.

The structure of the transition state is estimated based on an energy profile, and the transition state is sought by an accurate calculation (a distance between the OH radical and the calculated oligomer).

In order to confirm whether the resulting structure of the transition state is correct or not, calculation according to an IR spectrum is performed. If there is only one peak in a range of negative values of the frequency, the transition state is correct.

While the optimization of the structure through using the confirmed structure, calculation is performed in a 0.005 angstrom step, where the OH radicals come close to or are distanced away from the calculated oligomer.

According to this calculation, plots can be obtained in a graph in which the vertical axis shows energy and the horizontal axis shows a reaction route (calculation is performed “right” and “left,” the transition state being a starting point). The calculation of the reaction route can give activation energy of the reaction, and change in enthalpy.

The present invention also provides a method for selecting a polymer having resistance to OH radical.

The method comprises the steps of: preparing a 0.15 wt % of aqueous solution comprising a homopolymer consisting of repeating units having an ion exchange group; adding 1.5 wt % hydrogen peroxide to the aqueous solution and allowing the mixture to stand at 60° C.; sampling a small amount from the mixture one hour after the mixture starts to stand at 60° C. (0 hour) and adding isopropanol to the sample to stop the reaction thus resulting in obtaining a reaction product; and determining a molecular weight of the resulting reaction product. According to the method of the invention, when a value obtained by normalizing the molecular weight of the reaction product with the molecular weight of the homopolymer ((Molecular weight of the reaction product)/(Molecular weight of a homopolymer)*100) is 50 or more, preferably 60 or more, more preferably 80 or more, the most preferably 100 or more, the polymer comprising the repeating unit is judged as a polymer having durability to OH radical.

The term “ion exchange group” as used herein refers to a group easily leaving a proton, such as sulfonate group. The calculation for normalizing the molecular weight of the reaction product with the molecular weight of the homopolymer used can be determined with the following equation:
Normalized value=100*(Molecular weight of the reaction product)/(Molecular weight of a homopolymer used).

Further, the method of the present invention further comprises a step of measuring a content of remaining ion exchange groups of the resulting reaction product, and when the content of the remaining ion exchange groups is 50% or more, preferably 79% or more, more preferably 80% or more, the most preferably 99% or more, the polymer comprising the repeating unit may be judged as a polymer having durability to OH radical.

“The method for selecting a polymer having resistance to OH radical” of the present invention may have the features of “the method for selecting a highly durable polymer” of the present invention as described above.

The present invention will be illustrated in more detail by means of Examples, but the present invention is not limited to the Examples.

### EXAMPLES

### Synthesis of Polymers

The following polymers comprising repeating units a) to f) (hereinafter referred to as “SPES-a” to “SPES-f,” respectively) were synthesized, and the identifications were performed according to lHNMR, FT-IR, and CHNS element analysis. 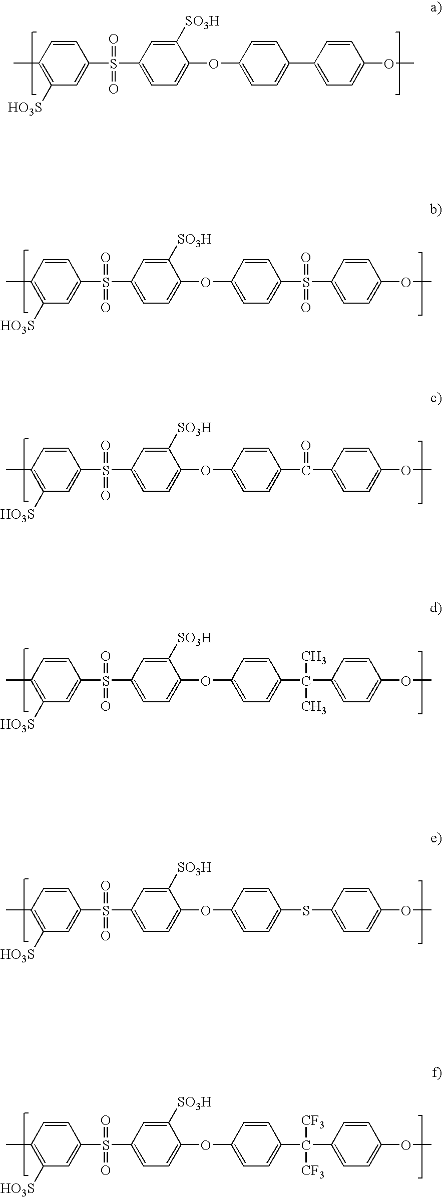
<Accelerated Resistance Test>

To an aqueous solution of the polymer obtained above (0.15 wt %) was added hydrogen peroxide (1.5 wt %), which was subjected to an accelerated resistance test at 60° C. Sampling was done every 30 minutes, isopropanol was added to the sample to stop the radical reaction, and it was dried. The amount of sulfonate groups in the resulting decomposed product was measured by ion spectral analysis (IPC). Also, the change in molecular weight with decomposition was measured using a gel permeation chromatography (GPC). In order to compare with the main test (OH radical test), a heat resistance test of the polymer SPES-a (at 120° C. for 24 hours) was also performed.

FIG. 1 is a graph showing comparison of the state of the polymer SPES-a before each test (spectrum shown as “initial”), the IR spectrum after the accelerated resistance test (OH radical test) (shown as “OH-test”), and the IR spectrum after the heat resistance test (shown as “Heat test”).

FIG. 1 shows that the spectrum (the position of the peak) after the heat resistance test did not change from that before the test, showing that the polymer SPES-a has durability at high temperatures. On the other hand, peaks derived from CH₂ and CH₃ were observed at around 2900 cm⁻¹ on the IR spectrum after the accelerated resistance test (OH radical test). This result shows that the polymer was decomposed by OH radicals and the SPES-a is sensitive to OH radical.

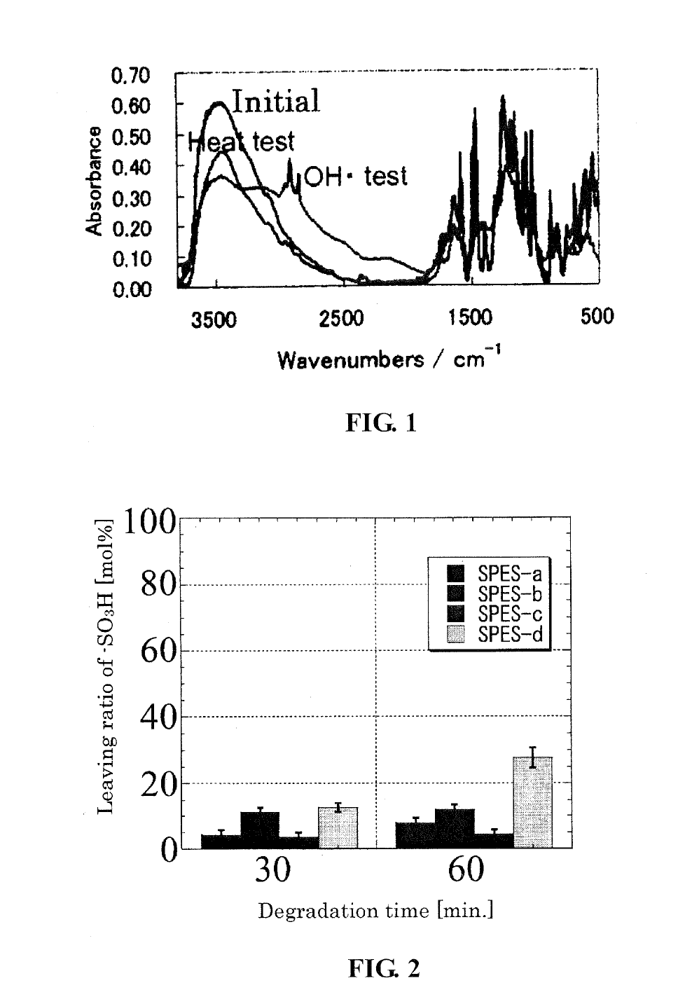

FIG. 2 shows results of IPC measurements. The vertical axis shows a percentage of the leaving sulfonate groups to the whole sulfonate groups. FIG. 2 shows that the percentage of the leaving sulfonate groups was at most about 30%, and though the severe test was performed, the obtained percentages were relatively low.

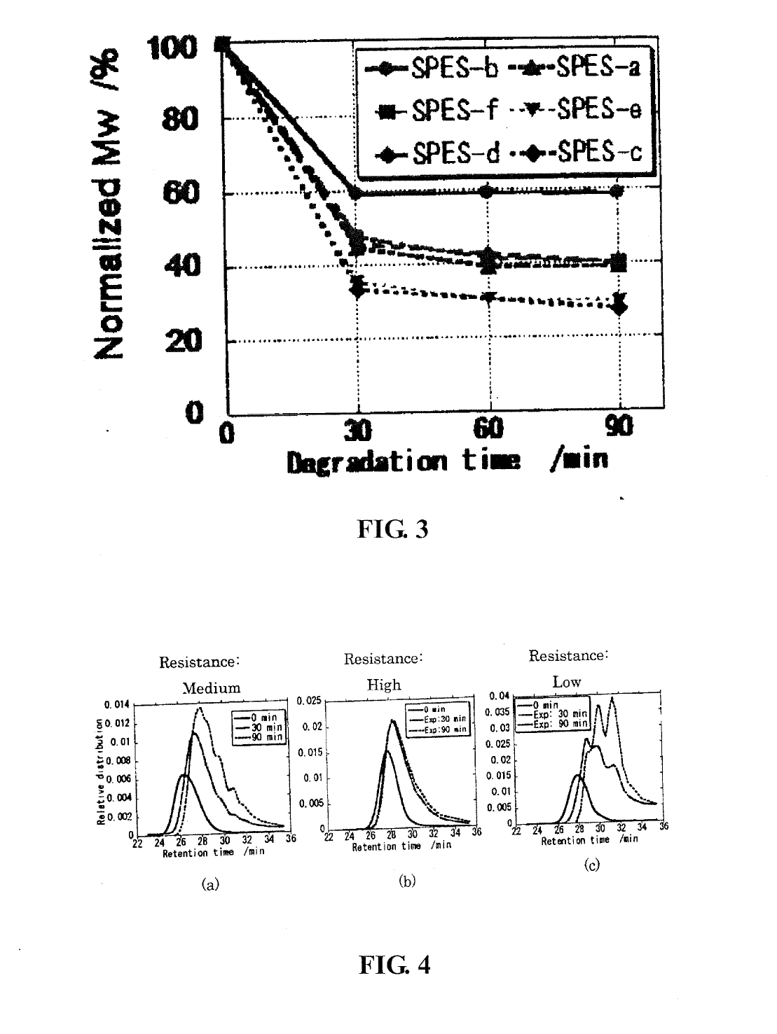

FIG. 3 shows results of GPC. The vertical axis thereof shows values normalized by the molecular weight. The closer the value is to 100%, the more the decomposition of the polymer is inhibited. FIG. 3 shows that the durability of the polymer depends on the monomer used. Further, it was found that the peak of the molecular weight distribution shifted to a region of a lower molecular weight over time. It was found that among the 6 polymers, the polymer SPES-b was not decomposed the best, that is, it had the resistance to OH radical.

<Decomposition Mechanism>

When the results of IPC (FIG. 2) and the results of GPC (FIG. 3) are compared, it is found that the decreased amount of the polymer is larger than the amount of the leaving sulfonate groups. For example, the leaving content of the sulfonate group of the polymer SPES-b was about 10 mol %; whereas the decreased molecular weight thereof was about 40% (the normalized Mw: about 60%). This shows that the cleavage reaction of the main chain proceeds more easily than the leaving reaction of the sulfonate groups does.

<Simulation of Cleavage of a Main Chain>

<<Time-Dependent Changes of Mw/Mn>>

FIG. 4 shows decomposition patterns of the polymers SPES-a (FIG. 4(a)), SPES-b (FIG. 4(b)) and SPES-c (FIG. 4(c)). The horizontal axis shows a retention time, and the vertical axis shows a relative distribution. As shown in FIGS. 4(a) to 4(c), it is understood that the decomposition pattern depends on the resistance to OH radical, shown in FIG. 3 (in FIG. 4, “resistance: middle,” and the like show the degree of resistance to OH radical shown in FIG. 3).

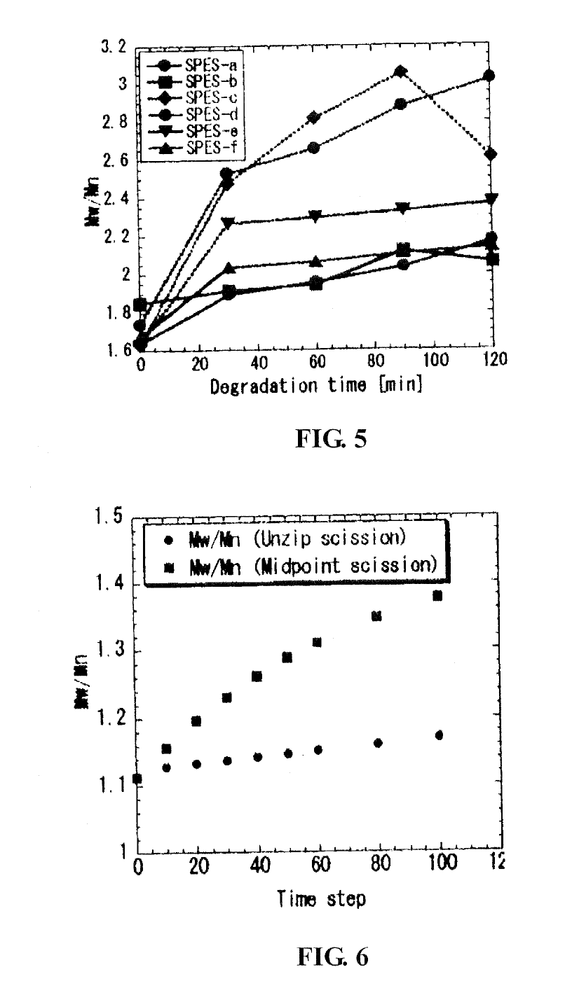

The distribution of SPES-b having high resistance shifted to a lower molecular weight region, while multiple peaks in the distribution of SPES-c having low resistance were observed in the lower molecular weight region. Values of the polydispersity (Mw/Mn) obtained from the samples in the accelerated resistance test are shown in FIG. 5. Bose's decompose model (Bose, et al., Macromol. Theo and Sim. 2004, 13, 453-473) were made, and the calculation was performed in two decomposition mechanisms, cleavage at terminal (high resistance) and cleavage at a central portion (low resistance). The results are shown in FIG. 6. FIG. 6 shows that the Mw/Mn values of polymers having low resistance changes drastically, compared with the Mw/Mn values of polymers having high resistance, and the decomposition of polymers having low resistance easily proceeds.

<<Relationship Between Structure Resistance and Cleavage Pattern>>

The results obtained in cleavage at terminals show that the molecular weight distribution of the polymer only shifted to a lower molecular weight region, and the peak of the molecular weight distribution was a unimodal. On the other hand, the results of cleavage at a central portion shows that the molecular weight distribution shifted slightly, but multiple peaks were observed in the lower molecular weight region. From these results, it is understood that for the highly resistant polymers, the cleavage hardly occurs in the central portion but decomposition occurs from the terminals. On the other hand, for the low resistant polymers, the decomposition probably proceeds from both of the terminals and the central portion.

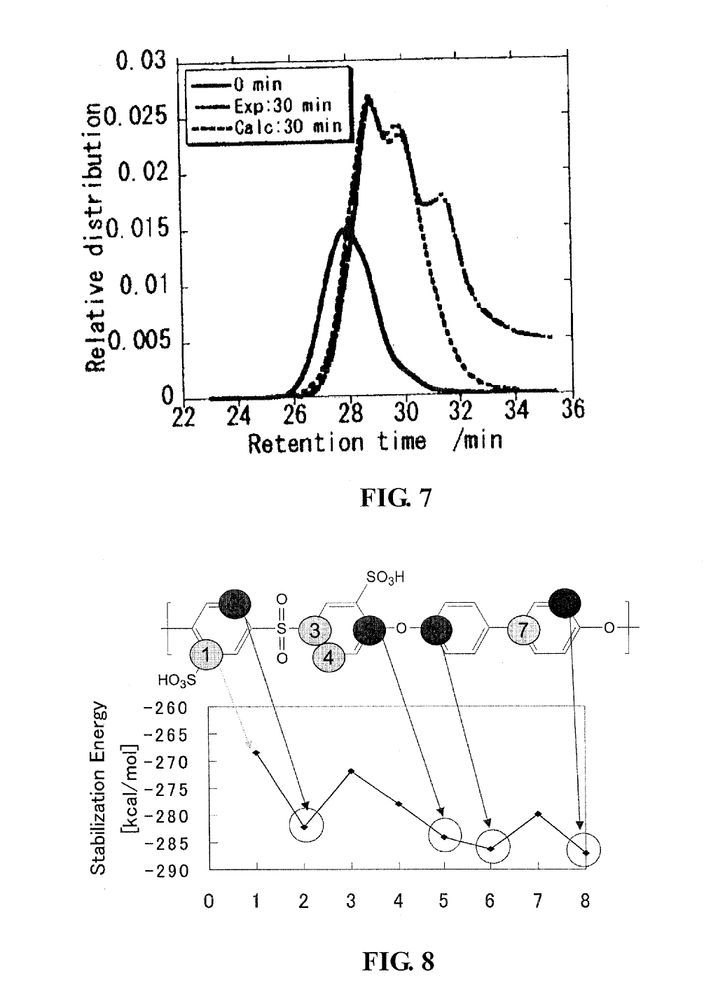

From the results of GPC, it can be considered that the decomposition reaction of the polymer proceeds at the end cleavage as well as at the central cleavage, and it was found that the cleavage speed depends on the molecular structure. In order to reproduce these phenomena, an extended model was performed. As a result, the decomposition pattern of the polymer SPES-c (FIG. 4(c)) could be reproduced (see FIG. 7). The decomposition pattern (FIG. 4(b)) of the polymer SPES-b having the unimodal decomposition pattern could be reproduced, which is not shown in figures.

<Quantum Chemical Calculation>

Using CAChe Worksystem Pro 6.1, 4-mer structures (oligomers having four successive repeating units) of the polymers SPES-a to SPES-f were produced, a reaction process between each oligomer and OH radical, a stabilization energy upon the formulation of an adduct with OH radical, and a molecular orbital energy were calculated using semi-empirical quantum calculation (AM1, PM3 and PM5). In calculations in which a solvent effect was considered, a COSMO method was used.

<<Reactivity of a Polymer>>

The calculation results of the stabilization energy when OH radicals approached to the polymer, obtained using the semi-empirical quantum calculation are shown in FIG. 8. FIG. 8 shows that the OH radical was more stable in the case in which it is added to carbon atoms on the benzene ring other than the carbon atom to which sulfone group or sulfonate group is attached, or to carbon atom on the ether bond, than in a case in which it is present around carbon atoms to which sulfone group or sulfonate group is attached. These results reproduce the above-described results, and support that the main chain cleavage reaction proceeds easily. It is found that when there is a substituent making a steric constraint such as the polymer SPES-d, it is unlikely that the radical approaches to the main chain.

According to the calculation of the molecular orbital energy calculation, it was found that the shapes of the HOMO and the LUMO were not changed by the solvent effect or the chain length.

<<Resistance index>>

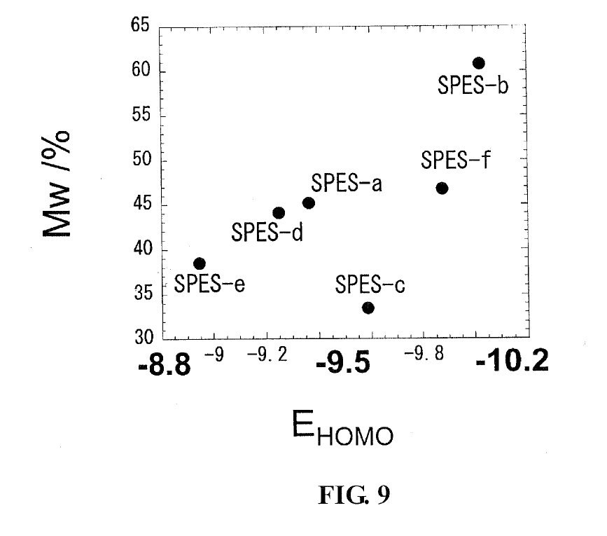

An HOMO energy, which is a parameter showing a degree how likely electrons are given, with respect to the polymers SPES-a to SPES-f was calculated. FIG. 9 depicts the resistance index wherein the horizontal axis shows HOMO calculation values, and the vertical axis shows percentages of the molecular weight after 30 minutes from decomposition. FIG. 9 shows that the lower the HOMO energy is (the HOMO energy becomes lower as it shifts to the right on the horizontal axis), the higher the molecular weight is, namely the polymer has the resistance to OH radical. FIG. 9 shows that the polymers having a structure that hardly give electrons, or has a low HOMO energy, give high resistance against OH radical and exhibit high durability.

The LUMO of the polymer SPES-c is located in a second or third repeating unit, thus resulting in, probably, easy central cleavage to show the low resistance.

What is claimed is that:

1. A hydrocarbon-based polymer comprising a repeating unit, wherein a value of an HOMO (Highest Occupied Molecular Orbital), obtained according to a quantum chemical calculation, of a calculated oligomer having four successive units, each of which is the repeating unit, is lower than a control HOMO value, obtained according to the quantum chemical calculation, of a control oligomer having four successive repeating units, each of which is represented by the formula (I):

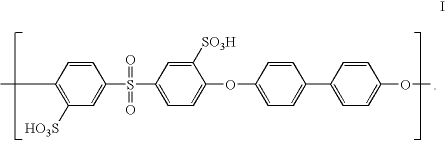

2. The polymer according to claim 1, wherein a position of the HOMO, obtained according to the quantum chemical calculation, of the calculated oligomer is not in a central portion of a main chain of the calculated oligomer.

3. The polymer according to claim 1, wherein an absolute value of the HOMO value, obtained according to the quantum chemical calculation, of the calculated oligomer is 1.1 times or more larger than an absolute value of the control HOMO value.

4. The polymer according to claim 1, wherein an LUMO (Lowest Unoccupied Molecular Orbital), obtained according to the quantum chemical calculation, of the calculated oligomer is not localized in the calculated oligomer.

5. The polymer according to claim 1, wherein the calculated oligomer excludes an oligomer in which the LUMO, obtained according to the quantum chemical calculation, is located in either of a second repeating unit or a third repeating unit in the calculated oligomer.

6. The polymer according to claim 1, wherein the polymer has a terminal group which makes the absolute value of the HOMO value larger.

7. The polymer according to claim 1, wherein the polymer has proton conductivity.

8. The polymer according to claim 1, wherein the polymer is used for a material for use in a fuel cell.

9. The polymer according to claim 1, wherein the polymer is used for an electrolyte membrane of a fuel cell.

10. A polymer comprising repeating units represented by the formula (II) wherein each of A and B independently represents 0 to 4 substituents:

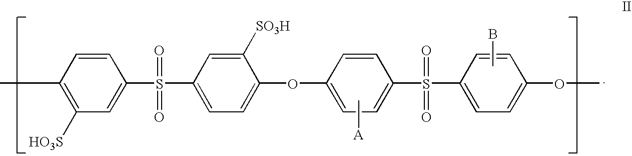

11. The polymer according to claim 10, wherein the polymer is used for a material for use in a fuel cell.

12. The polymer according to claim 10, wherein the polymer is used for an electrolyte membrane of a fuel cell.

13. A hydrocarbon-based polymer comprising a repeating unit represented by the formula (III) in which X is a bivalent group including a single bond, and each of A′ and B′ independently represents 0 to 4 substituents, wherein a value of an HOMO (Highest Occupied Molecular Orbital), obtained according to a quantum chemical calculation, of a calculated oligomer having four successive units, each of which is the repeating unit, is lower than a control HOMO value, obtained according to the quantum chemical calculation, of a control oligomer having four successive units, each of which is represented by the formula (I):

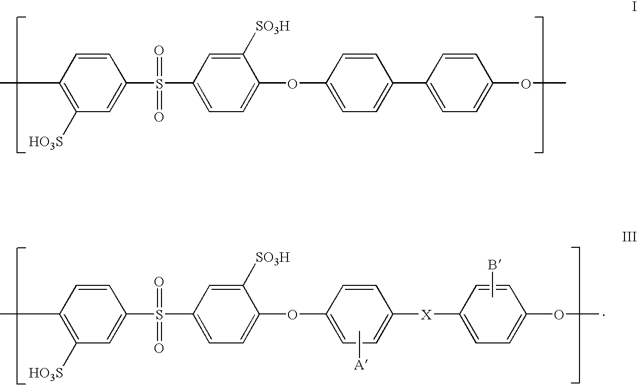

14. The polymer according to claim 13, wherein a position of the HOMO, obtained according to the quantum chemical calculation, of the calculated oligomer is not in a central portion of a main chain of the calculated oligomer.

15. The polymer according to claim 13, wherein an absolute value of the HOMO value, obtained according to the quantum chemical calculation, of the calculated oligomer is 1.1 times or more larger than an absolute value of the control HOMO value.

16. The polymer according to claim 13, wherein an LUMO (Lowest Unoccupied Molecular Orbital), obtained according to the quantum chemical calculation, of the calculated oligomer is not localized in the calculated oligomer.

17. The polymer according to claim 13, wherein the calculated oligomer excludes an oligomer in which the LUMO, obtained according to the quantum chemical calculation, is located in either of a second repeating unit or a third repeating unit in the calculated oligomer.

18. The polymer according to claim 13, wherein the polymer has a terminal group which makes the absolute value of the HOMO value larger.

19. The polymer according to claim 13, wherein the polymer has proton conductivity.

20. The polymer according to claim 13, wherein the polymer is used for a material for use in a fuel cell.

21. The polymer according to claim 13, wherein the polymer is used for an electrolyte membrane of a fuel cell.

22. A material for use in a fuel cell comprising the polymer according to claim 1.

23. An electrolyte membrane used for a fuel cell comprising the polymer according to claim 1.

24. A fuel cell comprising the polymer according to claim 13.

25. A method for selecting a highly durable polymer comprising the steps of:
calculating a calculated value of an HOMO (Highest Occupied Molecular Orbital) of a calculated oligomer having four successive repeating units, each of which is a repeating unit which constructs a polymer of interest, according to an quantum chemical calculation;
calculating a control HOMO value of a control oligomer having four successive repeating units, each of which is represented by the formula (I), according to the quantum chemical calculation; and
comparing the calculated HOMO value with the control HOMO value, and selecting the polymer of interest comprising the repeating unit as a highly durable polymer, if the calculated HOMO value is lower than the control HOMO value:

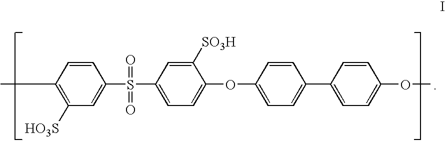

26. The method according to claim 25, wherein when a position of the HOMO, obtained according to the quantum chemical calculation, of the calculated oligomer is not in a central portion of a main chain of the calculated oligomer, the polymer is selected as a highly durable polymer.

27. The method according to claim 25, wherein an absolute value of the calculated HOMO value, obtained according to the quantum chemical calculation, of the calculated oligomer is 1.1 times or more larger than an absolute value of the control HOMO value.

28. The method according to claim 25, further comprising the step of:
selecting the polymer comprising the repeating unit as a highly durable polymer, if an LUMO (Lowest Un occupied Molecular Orbital), obtained according to the quantum chemical calculation, of the calculated oligomer is not localized in the calculated oligomer.

29. The method according to claim 25, further comprising the step of:
excluding the polymer comprising the repeating units when the LUMO, obtained according to the quantum chemical calculation, of the calculated oligomer is located in either of a second repeating unit or a third repeating unit of the calculated oligomer.

30. The method according to claim 25, a polymer having a terminal group which makes the absolute value of the calculated HOMO value of the calculated oligomer larger is selected as a highly durable polymer.

31. A method for selecting a polymer having a durability to OH radical comprising the steps of:
preparing a 0.15 wt % aqueous solution comprising a homopolymer consisting of repeating units having an ion exchange group;
adding 1.5 wt % hydrogen peroxide to the aqueous solution and allowing the mixture to stand at 60° C.;
sampling a small amount from the mixture one hour after the mixture is started to allow to stand at 60° C. (0 hour) and adding isopropanol to the sample to stop the reaction thus obtaining a reaction product; and
measuring a molecular weight of the resulting reaction product,
wherein when a value obtained by normalizing the molecular weight of the reaction product with the molecular weight of the homopolymer ((Molecular weight of the reaction product)/(Molecular weight of a homopolymer)*100) is 50 or more, the polymer comprising the repeating unit is judged as a polymer having durability to OH radical.

32. The method according to claim 31, further comprising a step of measuring a content of remaining ion exchange groups of the resulting reaction product,
wherein when the content of the remaining ion exchange groups is 50% or more, the polymer comprising the repeating units is judged as a polymer having durability to OH radical.
